(19) United States
(12) Patent Application Publication
(10) Pub. No.: US 2024/0353048 A1
(43) Pub. Date: Oct. 24, 2024

(54) JOINT WITH BUILT-IN FILTER

(71) Applicant: FUJIKIN INCORPORATED, Osaka-shi (JP)

(72) Inventors: Yasumasa Yanagida, Osaka-shi (JP); Koji Hiramatsu, Osaka-shi (JP); Tomohiro Mouri, Osaka-shi (JP); Tadayuki Yakushijin, Osaka-shi (JP); Kunihiko Daido, Osaka-shi (JP)

(73) Assignee: FUJIKIN INCORPORATED, Osaka-shi (JP)

(21) Appl. No.: 18/685,549

(22) PCT Filed: Jun. 30, 2022
(86) PCT No.: PCT/JP2022/026215

§ 371 Date: Feb. 22, 2024

(30) Foreign Application Priority Data
Sep. 7, 2021 (JP) 2021-145648

(51) Int. Cl. F16L 55/24; B01D 46/24

(52) U.S. Cl. CPC F16L 55/24; B01D 46/2403

(57) ABSTRACT

The present invention has a purpose of providing a joint with a built-in filter capable of replacing the filter without requiring removal of the joint from piping, thereby facilitating the replacement of the filter. The joint with the built-in filter includes: first and second inlet/outlet sections; a communication space formed to communicate with the first and second inlet/outlet sections; and a maintenance opening sealed in an airtight manner during non-maintenance. A filter element has: a cylindrical filter body; a base end section attached to an opening at one end of the filter body in an airtight manner and including a seal ring disposed between an outer circumferential surface thereof and an inner surface of the communication space; and a tip section disposed to seal an opening at the other end of the filter body in the airtight manner.

### TECHNICAL FIELD

The present invention relates to a joint with a built-in filter that is arranged in a channel, through which a high-pressure fluid such as hydrogen flows, and removes impurities.

### BACKGROUND ART

Use of high-pressure hydrogen gas has expanded to fuel cell vehicles and other applications. For example, when a fuel cell is replenished with the high-pressure hydrogen gas at a hydrogen station or the like, there is a possibility that impurities are contained in the hydrogen gas and adversely affect the fuel cell. Thus, the impurities in the hydrogen gas has to be removed. It is necessary to install a filter system in a hydrogen gas piping channel in order to remove the impurities.

As a system for removing the impurities from the hydrogen gas, a joint with a built-in filter in the middle of a pipe is disclosed in PTL 1 and PTL 2. FIG. 6 illustrates the joint disclosed in PTL 1. FIG. 7 illustrates the joint disclosed in PTL 2.

The joint in FIG. 6 is a joint in which a body 110 has a pipe connection section 120 that is connected to the pipe, in which a cap 111 has a pipe connection section 130 that is connected to the pipe, and which is arranged in the middle of the pipe. A cylindrical space section 122 is formed inside the body 110, a filter element 113 having a bottomed section 140 is arranged in the cylindrical space section 122, the filter element 113 is connected to a holder 143 via a sealing mechanism 115, and the holder 143 has a through-hole and communicates with the pipe connection section 120. The cap 111 is formed with a channel 128 that communicates with the pipe, and the cap 111 is threaded to the body 110. When the cap 111 is threaded, the cap 111 compresses a spring 114 provided to the right thereof, a compressive force thereof presses the filter element 113 in a right direction, and an O-ring between the holder 143 and the body 110 is compressed for sealing.

In the joint illustrated in FIG. 7, a joint body 220 of a fitting with a built-in filter 210 includes a first inlet/outlet section 221 and a second inlet/outlet section 222, and each of these inlet/outlet sections is connected to the pipe. The joint body 220 is formed with a communication space 224 therein. A filter element 240 is arranged in the communication space 224. The filter element 240 includes a filter body 241 and a cylindrical base end section 242. The cylindrical base end section 242 is perforated with a base end section through-hole 242b for communicating between an opening of the filter body 241 and the second inlet/outlet section 222, has one end fixed to the opening of the filter body 241 in an airtight manner, has the other end threaded to a filter element installation female screw 25 formed on an inner circumference of the joint body 220, and is thereby joined in the airtight manner. The base end section 242 is formed with a flange section 242a that has a larger diameter than an outer shape of the filter body 241. This flange section 242a is formed with a tool engagement section 243. The joint body 20 is further formed with a maintenance opening 223. During maintenance, a tool is inserted through the maintenance opening 223, and a tool tip is engaged with the tool engagement section 243. Then, the tool is turned to allow attachment/detachment of the filter element 240.

### CITATION LIST

### Patent Literature

PTL 1: JP2016-155061A

PTL 2: JP2021-089004A

### SUMMARY OF INVENTION

### Technical Problem

The joint with the built-in filter illustrated in FIG. 6 is inherent to the following problems. The first problem is that the pipe connection section 130, through which the fluid is flowing, has to be removed during the maintenance of the filter element 113. The second problem is that, when a fluid pressure on the pipe connection section 120 side becomes high, the filter element 113 moves to the left against an urging force of the spring 114, which loosens the seal (O-ring) between the body 110 and the holder 143. The joint with the built-in filter 210 illustrated in FIG. 7 is inherent to the following problem. Since the filter element 240 is threaded to the joint body 220, the filter element 240 does not move even with an increase in the fluid pressure on the second inlet/outlet section side. However, since the tool has to be engaged with the tool engagement section 243, which is located at the back of the communication space 224, for unthreading, there is the need for attaching/detaching the filter element 240.

The invention has a purpose of providing a joint with a built-in filter capable of replacing the filter without requiring removal of the joint from a pipe, thereby facilitating the replacement of the filter.

### Solution to Problem

The invention (1) is a joint with a built-in filter having:

a joint body that includes: a first inlet/outlet section and a second inlet/outlet section, each of which is connected to piping through which a fluid flows; a communication space that is formed to communicate between the first inlet/outlet section and the second inlet/outlet section; and a maintenance opening that communicates with the communication space and is sealed in an airtight manner during non-maintenance; and

a filter element that is arranged in the communication space and includes: a cylindrical filter body; a base end section arranged in an opening at one end of the filter body in an airtight manner, the base end section being perforated with a through-hole that communicates with the first inlet/outlet section or the second inlet/outlet section in the airtight manner; and a tip section that is disposed to close an opening at another end of the filter body in the airtight manner, in which

the filter element is movably arranged in a state of slidingly contacting the communication space, and

an outer circumferential surface of the base end section includes a seal ring that seals a clearance with an inner circumferential surface of the communication space in the airtight manner.

In the joint with the built-in filter according to the invention (1), the filter element is movably arranged in the state of slidingly contacting the communication space, and the outer circumferential surface of the base end section includes the seal ring that seals the clearance with the inner circumferential surface of the communication space in the airtight manner. Thus, even when a fluid pressure fluctuates on an upstream side or a downstream side of a fluid channel, and the filter element thereby moves, airtightness between the joint body and the filter element is not degraded.

The invention (2) is the joint with the built-in filter in the invention (1) in which the maintenance opening has a predetermined opening size that allows the filter element to be inserted/removed therethrough during maintenance, and is disposed at a predetermined position in the joint body, and a surface on the maintenance opening side of the tip section includes locking means for inserting/removing the filter element by using a tool.

In the joint with the built-in filter of the invention (2), the locking means, which is provided in the tip section of the filter element, is close to the maintenance opening at the time of inserting/removing the filter element. Thus, work of inserting/removing the filter element is facilitated. Furthermore, since the filter element is not fixed to the joint body by threading, there is no need to turn the filter element for unthreading, and the filter element only needs to be inserted/removed linearly, the work is further facilitated.

The invention (3) is the joint with the built-in filter in the invention (1) or (2) characterized that the locking means is a screw hole.

In the invention (3), since the locking means is the screw hole, machining is facilitated, and cost reduction can be achieved. A simple tool can be used since a male screw only needs to be formed at a tip of the tool.

The invention (4) is a joint with a built-in filter having:

a joint body that includes: a first inlet/outlet section and a second inlet/outlet section, each of which is connected to piping through which a fluid flows; a communication space that is formed to communicate between the first inlet/outlet section and the second inlet/outlet section; and a maintenance opening that communicates with the communication space and is sealed in an airtight manner during non-maintenance; and

a filter element that is arranged in the communication space and includes: a cylindrical filter body; a base end section arranged in an opening at one end of the filter body in an airtight manner, the base end section being perforated with a through-hole that communicates with the first inlet/outlet section or the second inlet/outlet section in the airtight manner; and a tip section that is disposed to close an opening at another end of the filter body in the airtight manner, in which

the filter element is movably arranged in a state of slidingly contacting the communication space,

an outer circumferential surface of the base end section includes a seal ring that seals a clearance with an inner circumferential surface of the communication space in the airtight manner,

the maintenance opening has a predetermined opening size that allows the filter element to be inserted/removed therethrough during maintenance, and is disposed at a predetermined position in the joint body, and furthermore, a sealing cap that includes a projected section penetrating the communication space is disposed in the maintenance opening, and

a coupling mechanism that couples the tip section and the projected section is provided between a surface on the maintenance opening side of the tip section and a surface on the tip section side of the projected section.

In the invention (4), the projected section at a tip of the sealing cap, which is inserted in the maintenance opening, penetrates the communication space, and the coupling mechanism couples this projected section and the tip section of the filter element. Thus, since the sealing cap and the filter element are coupled, the filter element can be inserted/removed by using the sealing cap even without using a tool for inserting/removing the filter element.

The invention (5) is the joint with the built-in filter in the invention (4) characterized that the coupling mechanism is an integrated structure in which the tip section and the projected section are integrated.

Since the invention (5) has the integrated structure in which the tip section and the projected section are integrated, it is possible to reduce the number of components and eliminating the need for coupling the tip section and the projected section.

The invention (6) is the joint with the built-in filter in the invention (4) characterized that the coupling mechanism functions by forming a male screw in one of the tip section and the projected section, forming a female screw in the other thereof, and threading the male screw into the female screw.

In the invention (6), the male screw is formed in one of the tip section and the projected section, the female screw is formed in the other thereof, and the coupling mechanism functions by threading the male screw into the female screw. Thus, the filter element can be inserted/removed conveniently and easily.

The invention (7) is the joint with the built-in filter in the invention (4) characterized that the coupling mechanism functions by forming a T-shaped projection in one of the tip section and the projected section, forming a T-shaped recess in the other thereof to be fitted to the T-shaped projection, and coupling the T-shaped projection and the T-shaped recess.

In the invention (7), the coupling mechanism functions by forming the T-shaped projection in one of the tip section and the projected section, forming the T-shaped recess in the other thereof to be fitted to the T-shaped projection, and coupling the T-shaped projection and the T-shaped recess. Thus, the filter element can be inserted/removed conveniently and easily.

### Advantageous Effects of Invention

According to the joint with the built-in filter in the invention, it is possible to replace the filter without requiring removal of the joint from a pipe, thereby facilitating the replacement of the filter.

### BRIEF DESCRIPTION OF DRAWINGS

FIG. 1 illustrates a first embodiment of a joint with a built-in filter according to the invention.

FIG. 2 illustrates a second embodiment of the joint with the built-in filter according to the invention.

FIG. 3 illustrates a third embodiment of the joint with the built-in filter according to the invention.

FIG. 4 illustrates a fourth embodiment of the joint with the built-in filter according to the invention.

FIG. 5 illustrates a fifth embodiment of the joint with the built-in filter according to the invention.

FIG. 6 illustrates a conventional joint with a built-in filter described in PTL 1.

FIG. 7 illustrates a conventional joint with a built-in filter described in PTL 2.

### DESCRIPTION OF EMBODIMENTS

A description will hereinafter be made on embodiments of the invention with reference to the drawings. In the following description, up/down and right/left respectively mean up/down and right/left of the drawings. The “up/down and right/left” are merely used for convenience. The “up/down and right/left” may be reversed upon installment.

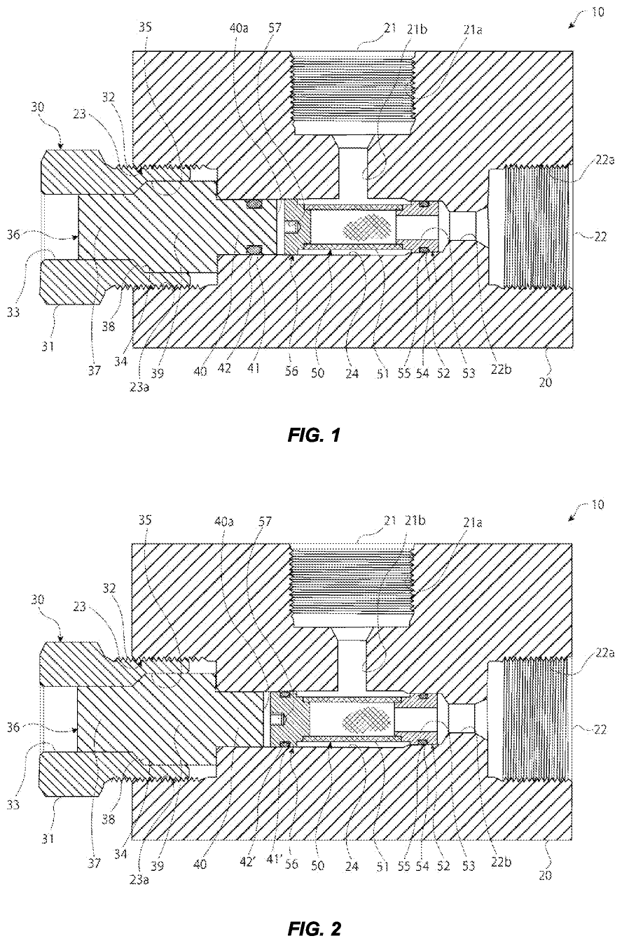

FIG. 1 illustrates a first embodiment of a joint with a built-in filter according to the invention. A joint body 20 of a joint with a built-in filter 10 includes a first inlet/outlet section 21 and a second inlet/outlet section 22. These inlet/outlet sections are connected to piping. A first inlet/outlet section female screw 21a and a second inlet/outlet section female screw 22a are used for connection to the piping. A communication space 24 is formed in the joint body 20. The communication space 24 communicates with the first inlet/outlet section 21 and the second inlet/outlet section 22 via a first communication path 21b and a second communication path 22b, respectively.

A filter element 50 is arranged in the communication space 24. In the filter element 50, a filter body 51 and a base end section 52 are disposed. The filter body 51 is formed of a filter material. The base end section 52 is perforated with a base end section through-hole 53 that communicates between an opening of the filter body 51 and the second inlet/outlet section 22, and has one end fixed to the opening of the filter body 51 in an airtight manner.

A base end section sealing groove 54 is formed on an outer circumferential surface of the base end section 52. A base end section seal ring 55 is fitted to this base end section sealing groove 54, and this base end section seal ring 55 is in close contact with an inner circumferential wall of the communication space 24.

A tip section 56 is disposed in the other opening of the filter body 51 in the airtight manner, and locking means 57 is formed in a left surface of the tip section 56. In the first embodiment, the locking means 57 is a screw hole. The filter element is inserted/removed when a tool is locked to this locking means 57.

A maintenance opening 23 is formed on a left surface of the joint body 20. This maintenance opening 32 is an opening through which the filter element 50 is inserted/removed. The maintenance opening 23 is an opening in an appropriate size and arranged at an appropriate position to insert/remove the filter element 50 therethrough.

A sealing cap 30 is inserted in the maintenance opening 23. The sealing cap 30 includes a perforated bolt 31 and a cap 36. The perforated bolt 31 is formed with a small-diameter hole 33, a tapered hole 34, and a large-diameter hole 35. An outer circumferential surface of the perforated bolt 31 is formed with a sealing cap male screw 32, and the sealing cap male screw 32 is threaded to a maintenance opening female screw 23a that is formed in the joint body 20.

The cap 36 is inserted in the perforated bolt 31. The cap 36 has a small-diameter section 37, a tapered section 38, a large-diameter section 39, and a projected section 40. The projected section 40 penetrates into the communication space 24. A seal-ring groove 41 is formed on an outer circumferential surface of the projected section 40, and a seal ring 42 is arranged in this groove. Since the seal ring 42 is also in close contact with an inner circumferential surface of the communication space 24, a fluid flowing through the first communication path 21b and the fluid flowing through the second communication path 22b do not leak out of the communication space 24 except from these communication paths. As illustrated in FIG. 1, the sealing cap 30 is configured as the perforated bolt 31 and the cap 36. Thus, even when the perforated bolt 31 is turned, the cap 36 is unlikely to be turned with the perforated bolt 31.

A projected section end surface 40a as a right end surface of the projected section 40 is disposed near a left end surface of the tip section 56. Thus, even when the fluid pressure on the second communication path side is increased, and the filter element 24 moves to the left, this projected section end surface 40a serves as a wall to inhibit further leftward movement of the filter element 24. As a result, the fluid does not leak out of the communication space 24 except from the predetermined fluid paths.

A description will be made on a procedure for removing the filter element 50 from the communication space 24 in the joint with the built-in filter 10 according to the first embodiment in FIG. 1. A fluid on-off valve that is attached to the piping is closed to shut off the flow of the fluid. Next, the sealing cap 30 is turned and removed. Then, the small-diameter section 31 of the cap 36 is grabbed and pulled out. At this stage, the locking means (screw hole) 57, which is formed in the left end surface of the tip section 56 of the filter element 50, can be seen through the maintenance opening 23. Thus, when a male screw of the tool that is formed with the male screw at a tip is threaded to the screw hole 57 and is pulled out, the filter element 50 can be removed. The filter element 50 can easily be arranged in the communication space 24 by reversing the removal procedure.

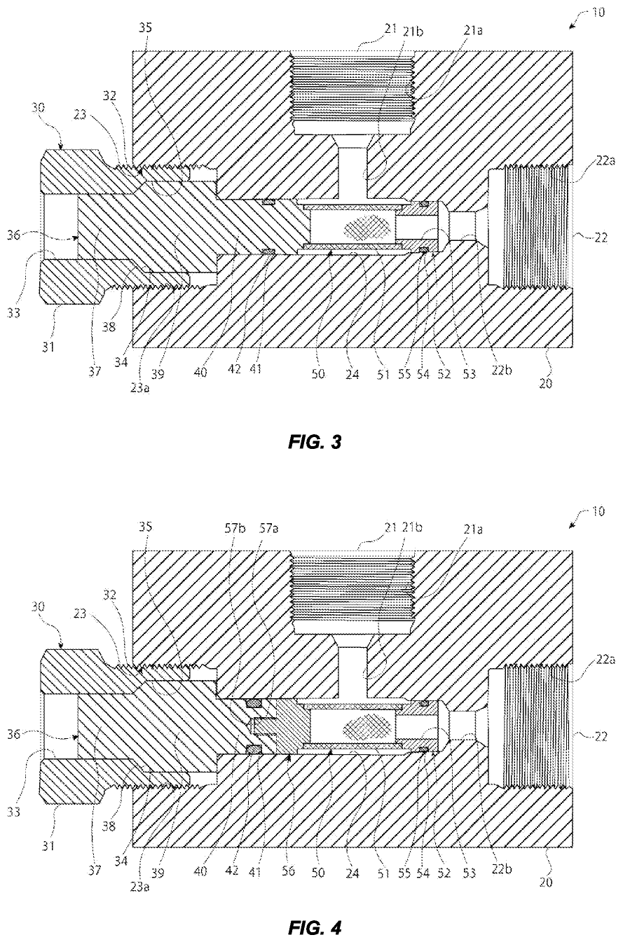

FIG. 2 illustrates a second embodiment, and differs from FIG. 1 only in a point that a seal-ring groove 41′ is formed on an outer circumferential surface of the tip section 56 and a seal ring 42′ is fitted to this seal-ring groove 41′. Also with such a structure, even when the filter element 24 moves to the left, this projected section end surface 40a serves as the wall to inhibit the further leftward movement of the filter element 24. As a result, the fluid does not leak out of the communication space 24 except from the predetermined fluid paths. The method for inserting/removing the filter element 50 is the same as that in the first embodiment.

FIG. 3 illustrates a third embodiment, and differs from FIG. 1 in a point that the tip section 56 and the projected section 40 are integrated. Due to this integration, the locking means 57 in FIG. 1 is no longer required and is eliminated. This integration prevents lateral movement of the filter element 50 even with the increase in the fluid pressure on the second communication path 22b side. Furthermore, the filter element 50 can easily be inserted/removed without use of a dedicated tool.

A description will be made on a procedure for removing the filter element 50 from the communication space 24 in the joint with the built-in filter 10 according to the third embodiment in FIG. 3. The fluid on-off valve that is attached to the piping is closed to shut off the flow of the fluid. Next, the sealing cap 30 is turned and removed. Then, the small-diameter section 37 of the cap 36 is grabbed and pulled out. Since the cap 36 and the filter element 50 are integrated, the filter element 50 can be removed. The filter element 50 can easily be arranged in the communication space 24 by reversing the removal procedure.

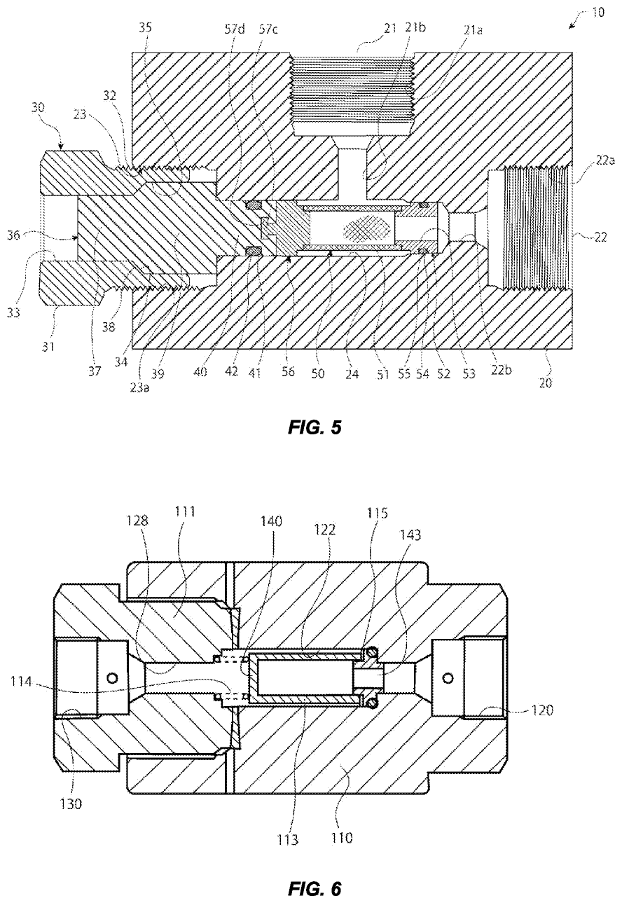

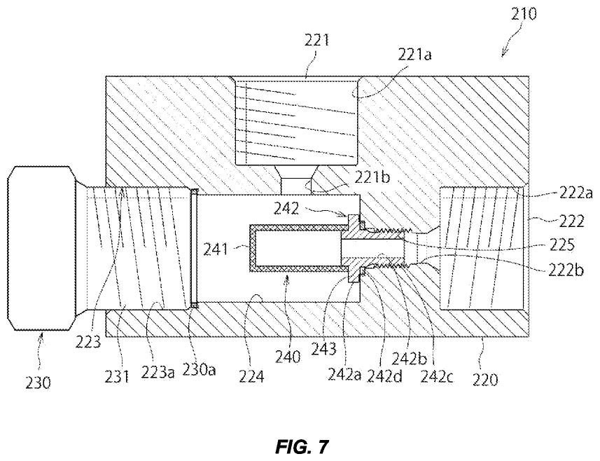

FIG. 4 illustrates a fourth embodiment, and differs from the third embodiment in FIG. 3 in points that the projected section 40 is not integrated with the tip section 56 and separates therefrom and that the projected section 40 and the tip section 56 are coupled by locking means (a male screw) 57a and locking means (a female screw) 57b. This coupling prevents the lateral movement of the filter element 50 even with the increase in the fluid pressure on the second communication path 22b side. Furthermore, the filter element 50 can easily be inserted/removed without use of the dedicated tool.

A description will be made on a procedure for removing the filter element 50 from the communication space 24 in the joint with the built-in filter 10 according to the fourth embodiment in FIG. 4. The fluid on-off valve that is attached to the piping is closed to shut off the flow of the fluid. Next, the sealing cap 30 is turned and removed. Then, the small-diameter section 37 of the cap 36 is grabbed and pulled out. Since the cap 36 and the filter element 50 are only coupled by the locking means (male screw) 57a and the locking means (female screw) 57b, the filter element 50 can easily be removed by turning the filter element 50 by hand. The filter element 50 can easily be arranged in the communication space 24 by reversing the removal procedure.

FIG. 5 illustrates a fifth embodiment, and differs from the fourth embodiment in FIG. 4 in a point that the locking means (male screw) 57a is locking means (a T-shaped projection) 57c and the locking means (a female screw) 57b is locking means (a T-shaped recess) 57d. The locking means (T-shaped recess) 57d is a groove that is formed in the projected section end surface 40a, and can be coupled to the locking means (T-shaped projection) 57c by fitting the locking means (T-shaped projection) 57c thereto through an opening on the side surface of the projected section 40. In the fifth embodiment, the locking means is T-shaped. However, the locking means does not have to be T-shaped but may be groove-shaped or a major arc-shaped as long as the locking means can achieve locking.

A description will be made on a procedure for removing the filter element 50 from the communication space 24 in the joint with the built-in filter 10 according to the fifth embodiment in FIG. 5. The fluid on-off valve that is attached to the piping is closed to shut off the flow of the fluid. Next, the sealing cap 30 is turned and removed. Then, the small-diameter section 37 of the cap 36 is grabbed and pulled out. Since the cap 36 and the filter element 50 are only coupled by combining the locking means (T-shaped projection) 57c and the locking means (T-shaped recess) 57d, the filter element 50 can easily be removed by moving the filter element 50 laterally. The filter element 50 can easily be arranged in the communication space 24 by reversing the removal procedure.

### Industrial Applicability

The use of the joint with the built-in filter according to the invention eliminates the need for attaching/detaching the filter without requiring separation of the piping from this joint.

### Reference Signs List

10: Joint with built-in filter
20: Joint body
21: First inlet/outlet section
21a: First inlet/outlet section female screw
21b: First communication path
22: Second inlet/outlet section
22a: Second inlet/outlet section female screw
22b: Second communication path
23: Maintenance opening
23a: Maintenance opening female screw
24: Communication space
30: Sealing cap
31: Perforated bolt
32: Sealing cap male screw
33: Small-diameter hole
34: Tapered hole
35: Large-diameter hole
36: Cap
37: Small-diameter section
38: Tapered section
39: Large-diameter section
40: Projected section
40a: Projected section end surface
41, 41′: Seal-ring groove
42, 42′: Seal ring
50: Filter element
51: Filter body
52: Base end section
53: Base end section through-hole
54: Base end section sealing groove
55: Base end section seal ring
56: Tip section
57: Locking means
57a: Locking means (male screw)
57b: Locking means (female screw)
57c: Locking means (T-shaped projection)
57d: Locking means (T-shaped recess)

1. A joint with a built-in filter comprising:
a joint body that includes: a first inlet/outlet section and a second inlet/outlet section, each of which is connected to piping through which a fluid flows; a communication space that is formed to communicate between the first inlet/outlet section and the second inlet/outlet section; and a maintenance opening that communicates with the communication space and is sealed in an airtight manner during non-maintenance; and
a filter element that is arranged in the communication space and includes: a cylindrical filter body; a base end section arranged in an opening at one end of the filter body in an airtight manner, the base end section being perforated with a through-hole that communicates with the first inlet/outlet section or the second inlet/outlet section in the airtight manner; and a tip section that is disposed to close an opening at another end of the filter body in the airtight manner, wherein
the filter element is movably arranged in a state of slidingly contacting the communication space, and
an outer circumferential surface of the base end section includes a seal ring that seals a clearance with an inner circumferential surface of the communication space in the airtight manner.

2. The joint with the built-in filter according to claim 1, wherein
the maintenance opening has a predetermined opening size that allows the filter element to be inserted/removed therethrough during maintenance, and is disposed at a predetermined position in the joint body, and
a surface on the maintenance opening side of the tip section includes locking means for inserting/removing the filter element by using a tool.

3. The joint with the built-in filter according to claim 1, wherein
the locking means is a screw hole.

4. A joint with a built-in filter comprising:
a joint body that includes: a first inlet/outlet section and a second inlet/outlet section, each of which is connected to piping through which a fluid flows; a communication space that is formed to communicate between the first inlet/outlet section and the second inlet/outlet section; and a maintenance opening that communicates with the communication space and is sealed in an airtight manner during non-maintenance; and
a filter element that is arranged in the communication space and includes: a cylindrical filter body; a base end section arranged in an opening at one end of the filter body in an airtight manner, the base end section being perforated with a through-hole that communicates with the first inlet/outlet section or the second inlet/outlet section in the airtight manner; and a tip section that is disposed to close an opening at another end of the filter body in the airtight manner, wherein
the filter element is movably arranged in a state of slidingly contacting the communication space,
an outer circumferential surface of the base end section includes a seal ring that seals a clearance with an inner circumferential surface of the communication space in the airtight manner,
the maintenance opening has a predetermined opening size that allows the filter element to be inserted/removed therethrough during maintenance, and is disposed at a predetermined position in the joint body, and furthermore, a sealing cap that includes a projected section penetrating the communication space is disposed in the maintenance opening, and
a coupling mechanism that couples the tip section and the projected section is provided between a surface on the maintenance opening section side of the tip section and a surface on the tip section side of the projected section.

5. The joint with the built-in filter according to claim 4, wherein
the coupling mechanism is an integrated structure in which the tip section and the projected section are integrated.

6. The joint with the built-in filter according to claim 4, wherein
the coupling mechanism functions by forming a male screw in one of the tip section and the projected section, forming a female screw in the other thereof, and threading the male screw into the female screw.

7. The joint with the built-in filter according to claim 4, wherein
the coupling mechanism functions by forming a T-shaped projection in one of the tip section and the projected section, forming a T-shaped recess in the other thereof to be fitted to the T-shaped projection, and coupling the T-shaped projection and the T-shaped recess.

8. The joint with the built-in filter according to claim 2, wherein
the locking means is a screw hole.
